(19) United States
(12) Patent Application Publication
(10) Pub. No.: US 2011/0018799 A1
(43) Pub. Date: Jan. 27, 2011

(54) COMPUTER SYSTEM HAVING WIRELESS OPTICAL PEN

(75) Inventor: TSUNG-YU LIN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/702,444

(22) Filed: Feb. 9, 2010

(30) Foreign Application Priority Data
Jul. 21, 2009 (CN) 200910304629.4

(51) Int. Cl. G06F 3/033

(52) U.S. Cl. 345/157; 345/179; 348/169

(57) ABSTRACT

An exemplary computer system includes a monitor, a wireless optical pen, a camera module, and a host. The wireless optical pen is configured for projecting an infrared light spot and emitting two visible light beams having different wavelengths to project two visible light spots. The camera module is mounted to the monitor and is configured for capturing images of movement tracks of the infrared light spot and capturing images of the two visible light spots. The host is configured for controlling a movement of a displayed cursor on the monitor and implementing a right-click input or a left-click input according to the images of the movement tracks of the infrared light spot and the images of one of the two visible light spots.

### BACKGROUND

1. Technical Field

The present disclosure relates to computer systems having wireless optical pens.

2. Description of Related Art

A typical computer system includes a host, and a mouse connected to the host. Control of a movement of a cursor, a left-click input, and a right-click input of the computer system can be implemented using the mouse. However, fine control of cursor movement is difficult to achieve with the mouse, and additionally the mouse may be connected to the host by wires which can inhibit fine control of the movement of the cursor.

Therefore, a computer system having a wireless optical pen, which can overcome the above problems, is needed.

### BRIEF DESCRIPTION OF THE DRAWINGS

FIG. 1 is an isometric and schematic view of a computer system including a camera module and a wireless optical pen, according to a first exemplary embodiment.

FIG. 2 is a sectional view of the wireless optical pen of the computer system of FIG. 1.

FIG. 3 shows an included angle between an optical axis of the camera module and a line perpendicular to a main surface of a writing panel.

FIG. 4 is an isometric and schematic view of a computer system according to a second exemplary embodiment.

### DETAILED DESCRIPTION

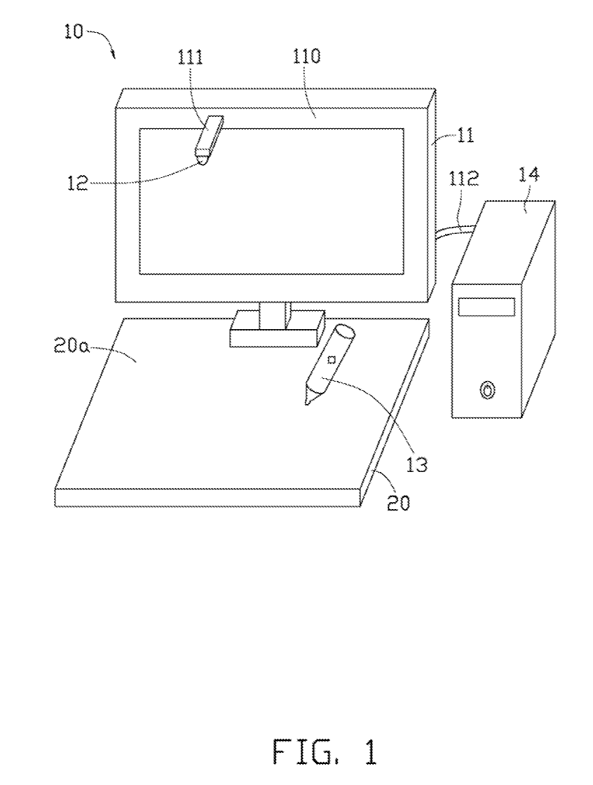

Referring to FIG. 1, a computer system 10, according to a first exemplary embodiment, includes a monitor 11, a camera module 12, a wireless optical pen 13, and a host 14.

The monitor 11 includes a top side 110 and a support 111. The support 111 is fixedly attached to the top side 110. The monitor 11 may be a liquid crystal display, a cathode ray tube display or other type displays. The monitor 11 stands on a main surface 20a of an object 20, such as a writing panel. The monitor 11 could alternately be arranged adjacent to a side of the writing panel 20. It is to be understood that in alternative embodiments, the support 111 may be attached to other sides of the monitor 11 rather than the top side 110.

The wireless optical pen 13 is configured for projecting an infrared light spot and emitting two visible light beams having different wavelengths to project two visible light spots. When in use, the wireless optical pen 13 may be held by a user and placed in contact with the main surface 20a. The infrared light is projected by the wireless optical pen 13 to form the infrared light spot on the main surface 20a, and the visible light beam can be projected by the wireless optical pen 13 to form the visible light spot on the main surface 20a in either of the two wavelengths.

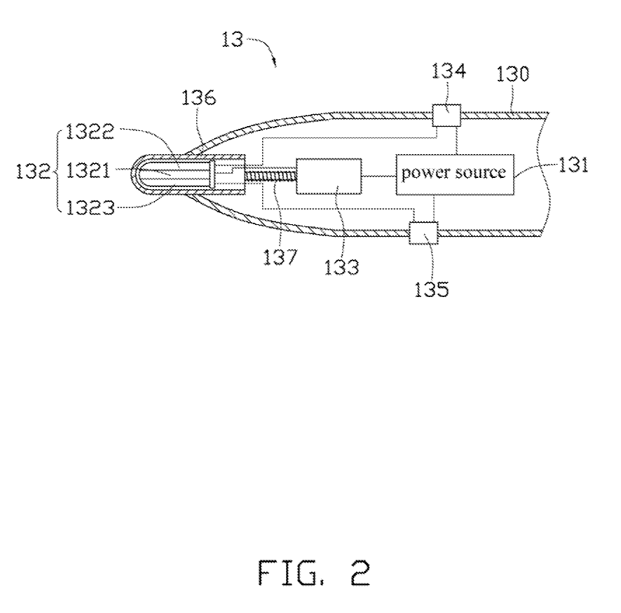

Referring to FIG. 2, the wireless optical pen 13 includes a body 130, a power source 131, a light source 132, three switches 133, 134, 135, a tip 136 and a spring 137.

The power source 131 is received in the body 130 and may be batteries or button cells connected in series. The tip 136 is partially received in an end of the body 130 and is transparent for infrared and visible light. The light source 132 is received in the tip 136 and includes an infrared light emitting portion 1321, a first visible light emitting portion 1322, and a second visible light emitting portion 1323. A wavelength of the light beam emitted from the first visible light emitting portion 1322 is different from that of the light beam emitted from the second visible light emitting portion 1323. In this embodiment, the first visible light emitting portion 1322 emits a blue light beam, and the second visible light emitting portion 1323 emits a green light beam.

The spring 137 is arranged between the tip 136 and the switch 133. The switch 133 is configured for controlling the infrared light emitting portion 1321 to turn on and turn off. When the tip 136 is depressed on the main surface 20a, the switch 133 is activated using the compressing spring 137 to turn on the infrared light emitting portion 1321 to emit the infrared light. The switches 134, 135 are push-button switches. The switch 134 is configured for controlling the first visible light emitting portion 1322 to turn on and turn off. The switch 135 is configured for controlling the second visible light emitting portion 1323 to turn on and turn off.

The camera module 12 is fixedly mounted to a distal end of the support 111 and is electrically connected to the host 14 by a wire 112. The camera module 12 is configured for capturing images of movement tracks of the infrared light spot on the main surface 20a and capturing images of visible light spots.

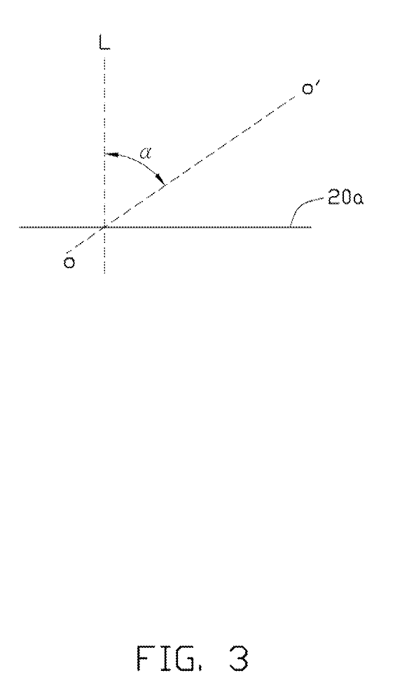

Referring to FIG. 3, an included angle α between an optical axis OO′ of the camera module 12 and a line L perpendicular to the main surface 20a is shown, and 0°≦α<90°. In this embodiment, α=0°, that is, the optical axis OO′ of the camera module 12 is substantially parallel to the line L perpendicular to the main surface 20a. Under this condition, trapezoidal distortion of the images captured by the camera module 12 is avoided.

The host 14 is configured for controlling movement of a displayed cursor on the monitor 11 and implementing a right-click input or a left-click input according to the images of the movement tracks of the infrared light spot and the images of the visible light spot. The images of the movement tracks of the infrared light spot and the visible light spot may be transmitted to the host 14 using the wire 112. The host 14 may include common hardware and software, such as a central processing unit, a hard disk, and an operating system etc. to implement related functions/achievements. For example, if the wireless optical pen 13 projects the visible light spot emitted from the first visible light emitting portion 1322 onto the main surface 20a, the host 14 determines that this is a left-click input of the computer system 10 according to the images of the visible light spot captured by the camera module 12. If the wireless optical pen 13 projects the visible light spot emitted from the second visible light emitting portion 1323 onto the main surface 20a, the host 14 determines that this is a right-click input of the computer system 10 according to the images of the visible light spot captured by the camera module 12.

When in use, the wireless optical pen 13 is held by the user and depressed on the main surface 20a. Therefore, an infrared light spot is formed on the main surface 20a. The images of the movement tracks of the infrared light spot are captured by the camera module 12 and are transmitted to the host 14. The host 14 processes the images of the movement tracks of the infrared light spot to control a movement of the displayed cursor on the monitor 11. Furthermore, the switch 134, for example, may be depressed by the user. Accordingly, the visible light spot emitted from the first visible light emitting portion 1322 is projected on the main surface 20a. The images of the visible light spot are captured by the camera module 12 and are transmitted to the host 14. The host 14 processes the images of the visible light spot to implement a left-click input of the computer system 10.

Because of the control of the movement of the cursor, a left-click input, and a right-click input of the computer system 10 can be implemented wirelessly, which is convenient.

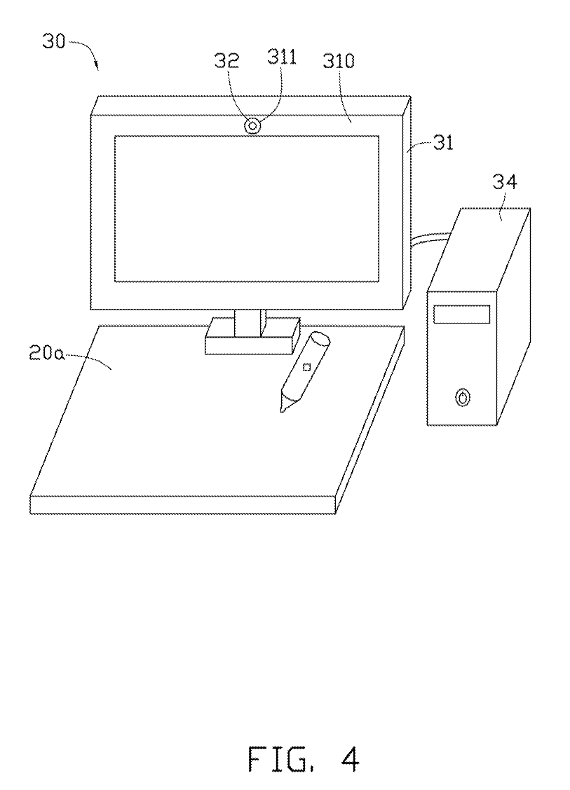

Referring to FIG. 4, a computer system 30, according to a second exemplary embodiment, is shown. The differences between the computer system 30 and the computer system 10 of the first embodiment are that in the computer system 30, a monitor 31 and a position of a camera module 32 are different.

The monitor 31 includes a top side 310. A receiving hole/groove 311 is defined in the top side 310. The camera module 32 is fixedly received in the receiving hole/groove 311. It is to be understood that, in this embodiment, an included angle between the optical axis of the camera module 32 and a line perpendicular to the main surface 20a is greater than zero degrees and smaller than 90 degrees. Under this condition, correction of trapezoidal distortion of the images captured by the camera module 32 may be needed. The host 34 may have related applications to achieve the correction of the trapezoidal distortion of the images. It is to be understood that in alternative embodiments, the hole/groove 311 may be defined in other sides of the monitor 31 other than the top side 310.

Advantages of the computer system 30 are similar to those of the computer system 10 of the first embodiment. Furthermore, because the camera module 32 is fixedly received in the monitor 31, the correction of the trapezoidal distortion of images may be easily done by the host 34.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer system, comprising:
a monitor;
a wireless optical pen configured for projecting an infrared light spot and emitting two visible light beams having different wavelengths to project two visible light spots,
a camera module mounted to the monitor and configured for capturing images of movement tracks of the infrared light spot and capturing images of the visible light spots; and
a host configured for controlling movement of a displayed cursor on the monitor and implementing a right-click input or a left-click input according to the images of the movement track of the infrared light spot and the images of one of the visible light spots.

2. The computer system of claim 1, wherein the monitor comprises a top side and a support fixedly attached to the top side, and the camera module is fixedly mounted on the support.

3. The computer system of claim 1, further comprising a writing panel, wherein an included angle between an optical axis of the camera module and a line perpendicular to a main surface of the writing panel satisfies the formula: 0°≦α<90°, where α is the included angle.

4. The computer system of claim 3, wherein α=0°.

5. The computer system of claim 1, wherein the wireless optical pen comprises a body, a tip, a light source and a power source electrically connected to the light source, the tip moveably and partially received in an end of the body, the light source received in the tip, and the power source received in the body.

6. The computer system of claim 5, wherein the light source comprises an infrared light emitting portion for emitting an infrared light, and two visible light emitting portions for emitting the two visible light beams.

7. The computer system of claim 6, wherein the light source further comprises three switches configured for respectively controlling the infrared light emitting portions and the two visible light emitting portions to turn on and turn off.

8. The computer system of claim 7, wherein the wireless optical pen further comprises a spring arranged between the tip and one of the switches.

9. The computer system of claim 1, wherein the monitor comprises a top side and a hole defined in the top side, and the camera module is fixedly received in the hole.
